(19) United States
(12) Patent Application Publication
(10) Pub. No.: US 2022/0251803 A1
(43) Pub. Date: Aug. 11, 2022

(54) WORK MACHINE AND CONTROL SYSTEM FOR WORK MACHINE

(71) Applicant: KOMATSU LTD., Minato-ku, Tokyo (JP)

(72) Inventors: Harunobu USHIJIMA, Minato-ku, Tokyo (JP); Satoru IDE, Minato-ku, Tokyo (JP); Hiroshi YAMASHITA, Minato-ku, Tokyo (JP)

(73) Assignee: KOMATSU LTD., Minato-ku, Tokyo (JP)

(21) Appl. No.: 17/622,344

(22) PCT Filed: Jul. 8, 2020
(86) PCT No.: PCT/JP2020/026675

§ 371 Date: Dec. 23, 2021

(30) Foreign Application Priority Data
Jul. 12, 2019 (JP) 2019-130543

(51) Int. Cl. E02F 9/20; E02F 9/26; E02F 9/24; E02F 9/12

(52) U.S. Cl. CPC E02F 9/2033; E02F 9/262; E02F 9/2285; E02F 9/123; E02F 9/24

(57) ABSTRACT

A work machine is improved in manipulability. The work machine includes a manipulation device, an actuator, a surrounding area monitoring device, and a controller. The manipulation device is manipulated to operate the work machine. The actuator drives the work machine in a manner corresponding to a manipulation of the manipulation device. The surrounding area monitoring device serves as a device for detecting whether an object to be recognized is present or not inside a set region that is set in a surrounding area of the work machine. The controller controls the work machine. When a prescribed manipulation device is manipulated in a case where it is detected that the object is present inside the set region, the controller restricts an operation of the actuator corresponding to a manipulation of the manipulation device.

### TECHNICAL FIELD

The present disclosure relates to a work machine and a control system for the work machine.

### BACKGROUND ART

The following apparatus has conventionally been proposed. A hydraulic excavator includes a revolving unit provided with a front work implement. The revolving unit is capable of revolving. Further, there is a region defined as a dangerous region where a human including a service worker may collide with the revolving unit that is revolving or the front work implement that moves while the revolving unit is revolving. When it is determined that an object to be recognized is present in the dangerous region, prescribed safety precautions are to be taken. Such safety precautions include one of safety means including: issuance of an alarm from a buzzer; and means for locking actuation of the hydraulic excavator (for example, see Japanese Patent Laying-Open No. 2004-343297 (PTL 1)).

### CITATION LIST

### Patent Literature

PTL 1: Japanese Patent Laying-Open No. 2004-343297

### SUMMARY OF INVENTION

### Technical Problem

According to the above-mentioned literature disclosing that actuation is locked based only on the determination result that an object to be recognized is present in the dangerous region, the operation of the work machine is locked irrespective of the intention of an operator. Thus, it has been demanded to allow deactivation of the work machine by the operator's intention only when required.

The present disclosure provides a work machine that can be improved in manipulability, and a control system that can improve the manipulability of the work machine.

### Solution to Problem

The present disclosure provides a work machine including a manipulation device, an actuator, a surrounding area monitoring device, and a controller. The manipulation device is manipulated to operate the work machine. The actuator drives the work machine in a manner corresponding to a manipulation of the manipulation device. The surrounding area monitoring device serves to detect whether an object to be recognized is present or not inside a set region that is set in a surrounding area of the work machine. The controller controls the work machine. When a prescribed manipulation device is manipulated in a case where it is detected that the object is present inside the set region, the controller restricts an operation of the actuator corresponding to a manipulation of the manipulation device.

### Advantageous Effects of Invention

According to the present disclosure, the work machine can be improved in manipulability.

### BRIEF DESCRIPTION OF DRAWINGS

FIG. 1 is a diagram illustrating an external appearance of a hydraulic excavator according to an embodiment.

FIG. 2 is a block diagram showing a system configuration of the hydraulic excavator.

FIG. 3 is a schematic diagram for illustrating each of regions set in a surrounding area of the hydraulic excavator.

FIG. 4 is a schematic diagram showing a process performed by an object sensing function.

FIG. 5 is a block diagram showing a system configuration of a hydraulic excavator according to a second embodiment.

FIG. 6 is a block diagram showing a system configuration of a hydraulic excavator according to a third embodiment.

FIG. 7 is a schematic diagram of a control system for a hydraulic excavator.

### DESCRIPTION OF EMBODIMENTS

In the following, embodiments will be described with reference to the accompanying drawings. In the following description, the same components are denoted by the same reference characters. Names and functions thereof are also the same. Accordingly, the detailed description thereof will not be repeated.

### First Embodiment

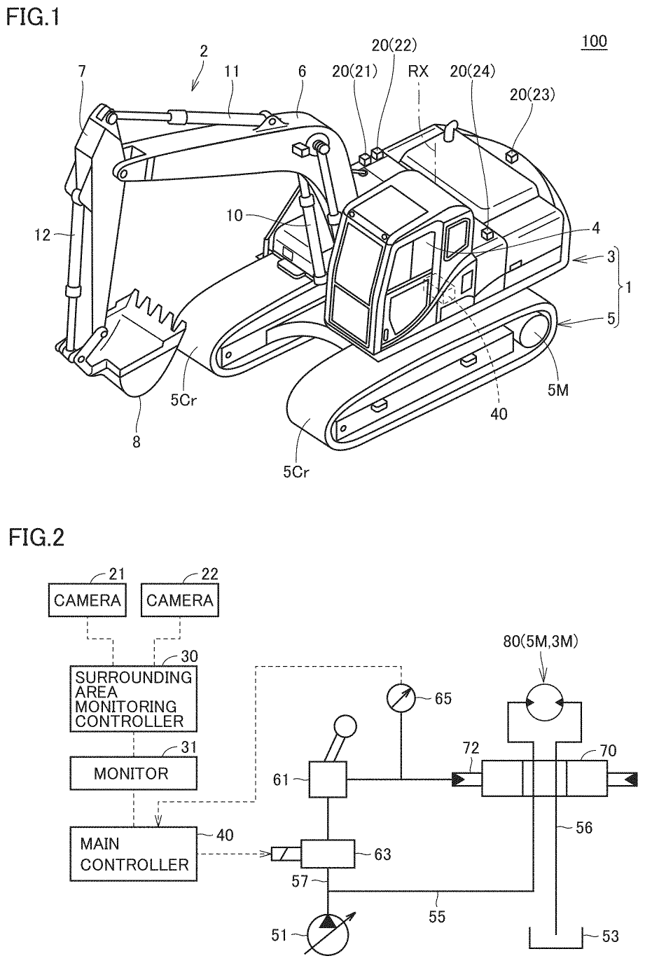

First, the configuration of a hydraulic excavator 100 will be hereinafter described as an example of a work machine. FIG. 1 is a diagram illustrating the external appearance of hydraulic excavator 100 according to an embodiment.

As shown in FIG. 1, hydraulic excavator 100 includes a body 1 and a work implement 2 that operates with hydraulic pressure. Body 1 includes a revolving unit 3 and a traveling unit 5. Traveling unit 5 includes a pair of right and left crawler belts 5Cr and a traveling motor 5M. Hydraulic excavator 100 can travel as crawler belts 5Cr rotate. Traveling motor 5M is an example of a traveling actuator for driving traveling unit 5. By driving by traveling motor 5M, crawler belts 5Cr rotate to thereby cause hydraulic excavator 100 to travel. Traveling motor 5M is a hydraulic motor that is actuated with hydraulic pressure. Note that traveling unit 5 may include wheels (tires).

During the operation of hydraulic excavator 100, traveling unit 5, more specifically, each crawler belt 5Cr, is situated on a reference surface, for example, a ground surface.

Revolving unit 3 is disposed on traveling unit 5 and supported by traveling unit 5. Revolving unit 3 is mounted on traveling unit 5 to be revolvable via a revolving mechanism in an upper portion of traveling unit 5. Revolving unit 3 is mounted on traveling unit 5 to be revolvable about a revolving axis RX with respect to traveling unit 5. Since traveling unit 5 is situated on the ground surface, revolving unit 3 is revolvable with respect to the ground surface.

Revolving unit 3 includes a cab 4. An occupant (an operator) of hydraulic excavator 100, who is aboard cab 4, controls hydraulic excavator 100. Cab 4 is equipped with an operator's seat on which an operator sits. The operator inside cab 4 can manipulate hydraulic excavator 100. The operator inside cab 4 can manipulate work implement 2, can manipulate revolving unit 3 to revolve with respect to traveling unit 5, and can manipulate hydraulic excavator 100 to travel with the help of traveling unit 5.

Revolving unit 3 includes: an engine compartment accommodating an engine; and a counterweight provided in a rear portion of revolving unit 3.

Work implement 2 is supported by revolving unit 3. Work implement 2 is pivotally supported on revolving unit 3 to be operable in the up-down direction, and performs such work as excavation of soil. Work implement 2 includes a boom 6, an arm 7, and a bucket 8. Boom 6 has a base end that is rotatably coupled to revolving unit 3. Arm 7 is rotatably coupled to a leading end of boom 6. Bucket 8 is rotatably coupled to a leading end of arm 7.

Work implement 2 includes a boom cylinder 10, an arm cylinder 11, and a bucket cylinder 12. Boom cylinder 10 drives boom 6. Arm cylinder 11 drives arm 7. Bucket cylinder 12 drives bucket 8. Each of boom cylinder 10, arm cylinder 11, and bucket cylinder 12 serves as a hydraulic cylinder driven with hydraulic oil supplied from a hydraulic pump (see FIG. 2). Each of boom 6, arm 7, and bucket 8 is driven by a hydraulic cylinder, so that work implement 2 can be operated.

Hydraulic excavator 100 is equipped with a camera 20. Camera 20 serves as an imaging device for imaging the surrounding area of hydraulic excavator 100 and obtaining images of the surrounding area of hydraulic excavator 100. Camera 20 is configured to be capable of obtaining current geographical features around hydraulic excavator 100 and also capable of recognizing the presence of an obstacle around hydraulic excavator 100.

Camera 20 includes a right front camera 21, a right side camera 22, a rear camera 23, and a left side camera 24. Right front camera 21 and right side camera 22 are disposed at the right side edge on the upper surface of revolving unit 3. Right front camera 21 is disposed forward of right side camera 22. Right front camera 21 and right side camera 22 are disposed in the vicinity of the center portion of revolving unit 3 in the front-rear direction to be arranged in line front to rear.

Rear camera 23 is disposed at the rear end of revolving unit 3 in the front-rear direction, and located in the center portion of revolving unit 3 in the right-left direction. At the rear end of revolving unit 3, a counter weight is provided for keeping the balance of the vehicle body during excavation and the like. Rear camera 23 is disposed on the upper surface of the counter weight. Left side camera 24 is disposed at the left side edge on the upper surface of revolving unit 3. Left side camera 24 is disposed in the vicinity of the center portion of revolving unit 3 in the front-rear direction.

In the present embodiment, the positional relation of the components in hydraulic excavator 100 will be described with respect to work implement 2.

Boom 6 of work implement 2 pivots about a boom pin provided at the base end of boom 6 with respect to revolving unit 3. A specific portion of boom 6 that pivots with respect to revolving unit 3, for example, the leading end of boom 6, moves along an arcuate track. A plane including this arcuate track is specified. In a plan view of hydraulic excavator 100, this plane is shown as a straight line. The direction in which this straight line extends corresponds to the front-rear direction of body 1 of hydraulic excavator 100 or the front-rear direction of revolving unit 3, and will be hereinafter also simply referred to as a front-rear direction. The right-left direction of body 1 of hydraulic excavator 100 (the vehicle width direction) or the right-left direction of revolving unit 3 corresponds to the direction orthogonal to the front-rear direction in a plan view, and will be hereinafter also simply referred to as a right-left direction.

With respect to the front-rear direction, work implement 2 protrudes from body 1 of hydraulic excavator 100 in the front direction that is opposite to the rear direction. In a facing forward view, the right side and the left side in the right-left direction correspond to the right direction and the left direction, respectively.

The front-rear direction corresponds to the front-rear direction of an operator sitting on an operator's seat inside cab 4. The direction in which the operator sitting on the operator's seat faces corresponds to the front direction. The direction rearward of the operator sitting on the operator's seat corresponds to the rear direction. The right-left direction corresponds to the right-left direction of the operator sitting on the operator's seat. In the state where the operator sitting on the operator's seat faces forward, the right side and the left side correspond to the right direction and the left direction, respectively.

Hydraulic excavator 100 is equipped with a main controller 40. Main controller 40 controls the operation of hydraulic excavator 100. The control of hydraulic excavator 100 by main controller 40 will be described later.

FIG. 2 is a block diagram showing the system configuration of hydraulic excavator 100. As shown in FIG. 2, hydraulic excavator 100 mainly includes a surrounding area monitoring controller 30, main controller 40, and a hydraulic circuit that extends from a hydraulic pump 51 to a hydraulic actuator 80. The solid line in FIG. 2 shows this hydraulic circuit. The broken line in FIG. 2 shows an electric circuit. Note that FIG. 2 shows only a part of the electric circuit included in hydraulic excavator 100 in the present embodiment.

The images of the surrounding area of hydraulic excavator 100 that are obtained with camera 20 shown in FIG. 1 are input into surrounding area monitoring controller 30. Among cameras 20 shown in FIG. 1, right front camera 21 and right side camera 22 are representatively shown in FIG. 2, but the images obtained with rear camera 23 and left side camera 24 are also naturally input into surrounding area monitoring controller 30. From the images captured by camera 20, surrounding area monitoring controller 30 produces surrounding images of hydraulic excavator 100 and causes a monitor 31 to display the produced images.

The surrounding images of hydraulic excavator 100 include a mono image formed of an image captured by one of right front camera 21, right side camera 22, rear camera 23, and left side camera 24. Further, the surrounding images of hydraulic excavator 100 include a bird's-eye-view image formed by synthesizing a plurality of images captured by right front camera 21, right side camera 22, rear camera 23, or left side camera 24.

Main controller 40 serves as a controller for controlling the entire operation of hydraulic excavator 100 and is configured of a central processing unit (CPU), a non-volatile memory, a timer, and the like. Main controller 40 causes monitor 31 to display the vehicle body information about hydraulic excavator 100. The vehicle body information about hydraulic excavator 100 includes, for example, the operation mode of hydraulic excavator 100, the amount of remaining fuel indicated by a fuel indicator, the temperature of coolant or the temperature of hydraulic oil that is indicated by a thermometer, the operation status of an air-conditioner, and the like.

The system shown in FIG. 2 is configured such that hydraulic pump 51 is driven by an engine (not shown) and the hydraulic oil discharged from hydraulic pump 51 is supplied through a main valve 70 to various kinds of hydraulic actuators 80. The hydraulic pressure is controlled to be supplied to and discharged from hydraulic actuator 80, to thereby control the operation of work implement 2, the revolution of revolving unit 3, and the traveling operation of traveling unit 5. Hydraulic actuator 80 includes traveling motor 5M shown in FIG. 1 and a revolving motor 3M. Hydraulic actuator 80 includes boom cylinder 10, arm cylinder 11, and bucket cylinder 12 that are shown in FIG. 1.

Revolving motor 3M is an example of the revolving actuator for driving revolving unit 3 to revolve. Revolving motor 3M drives revolving unit 3 to perform a revolving operation. Revolving motor 3M is a hydraulic motor actuated with hydraulic pressure.

Hydraulic pump 51 supplies hydraulic oil used for causing traveling unit 5 to travel and causing revolving unit 3 to revolve. Hydraulic pump 51 is coupled with the drive shaft of the engine. The rotational driving force of the engine is transmitted to hydraulic pump 51 to thereby drive hydraulic pump 51, so that hydraulic pump 51 discharges the pressurized oil. Hydraulic pump 51 serves as a variable displacement hydraulic pump, for example, having a swash plate that is tilted at various angles so as to change the discharge volume.

In tank 53, oil used by hydraulic pump 51 is stored. As hydraulic pump 51 is driven, the oil stored in tank 53 is suctioned from tank 53 and supplied to main valve 70 through a hydraulic oil supply path 55.

Main valve 70 is a spool type valve configured such that a rod-shaped spool is moved to switch the direction in which the hydraulic oil flows. The spool axially moves to adjust the amount of hydraulic oil to be supplied to hydraulic actuator 80, i.e., traveling motor 5M and revolving motor 3M, boom cylinder 10, arm cylinder 11, and bucket cylinder 12. Hydraulic oil is to be supplied to hydraulic actuator 80 for activating the same.

The hydraulic oil discharged from main valve 70 is returned to tank 53 through a hydraulic oil discharge path 56.

Some of oil delivered from hydraulic pump 51 is branched from hydraulic oil supply path 55 and flows into a pilot oil path 57. Some of oil delivered from hydraulic pump 51 is reduced in pressure in a self-pressure reduction valve, and the oil reduced in pressure is used as pilot oil. Pilot oil is to be supplied to main valve 70 for activating the spool of main valve 70. Main valve 70 has a pair of pilot ports 72. As the pilot oil having prescribed hydraulic pressure (pilot pressure) is supplied to each pilot port 72, the spool moves according to the pilot pressure to thereby control main valve 70.

A manipulation device 61 is provided in pilot oil path 57. Manipulation device 61 is manipulated to operate hydraulic excavator 100. The pilot pressure applied to main valve 70 is controlled by manipulation of manipulation device 61. Manipulation device 61 has a manipulation lever. The pilot oil with pressure corresponding to the amount of manipulation of the manipulation lever is output from manipulation device 61 and supplied to each pilot port 72 of main valve 70.

Manipulation device 61 includes a revolving-motion manipulation device.

The revolving-motion manipulation device is manipulated by an operator to move revolving unit 3 to revolve. As revolving unit 3 is moved to revolve, the position of revolving unit 3 changes. The revolving-motion manipulation device is disposed, for example, on the side portion of the operator's seat in cab 4. The revolving-motion manipulation device is disposed, for example, on the left side of the operator's seat. The revolving-motion manipulation device includes a revolving-motion manipulation lever, for example.

Manipulation device 61 includes a traveling-motion manipulation device. The traveling-motion manipulation device is manipulated by an operator so as to cause hydraulic excavator 100 to travel, more particularly, so as to drive traveling unit 5 to move hydraulic excavator 100. As hydraulic excavator 100 travels, the position of hydraulic excavator 100 changes. The traveling-motion manipulation device is disposed, for example, forward of the operator's seat in cab 4. The traveling-motion manipulation device includes, for example, a pair of traveling-motion manipulation levers or pedals for the respective crawler belts 5Cr on the right and left sides.

Pilot oil path 57 is provided with a solenoid valve 63. Solenoid valve 63 is connected to pilot oil path 57 upstream from manipulation device 61 in the direction in which the pilot oil flows. Upon reception of a control signal from main controller 40, solenoid valve 63 is switched between an opened state and a closed state. Solenoid valve 63 adjusts the pilot pressure based on the control signal from main controller 40. Solenoid valve 63 controls pilot oil path 57 to be opened and closed based on the control signal from main controller 40.

When solenoid valve 63 is in an opened state, the pilot oil is supplied through solenoid valve 63 to manipulation device 61. When the manipulation of manipulation device 61 is activated, the flow direction and the flow rate of the hydraulic oil that is supplied from hydraulic pump 51 through main valve 70 to hydraulic actuator 80 are adjusted in accordance with the manipulation of manipulation device 61. When solenoid valve 63 is in a closed state, pilot oil path 57 is blocked to thereby interrupt supply of the pilot oil to manipulation device 61. Since solenoid valve 63 in a closed state blocks the pilot pressure, the hydraulic oil is no longer supplied from hydraulic pump 51 to hydraulic actuator 80 even by manipulation of manipulation device 61, with the result that the operation of hydraulic actuator 80 is restricted.

In this way, supply of hydraulic oil to hydraulic actuator 80 is controlled in accordance with the manipulation of manipulation device 61, to thereby control the output of hydraulic actuator 80, so that the traveling operation of traveling unit 5 and the revolving operation of revolving unit 3 are controlled.

A branch pipe is connected to pilot oil path 57 downstream from manipulation device 61 in the flow direction of the pilot oil. This branch pipe is provided with a pressure gauge 65. Pressure gauge 65 detects the pressure of the pilot oil (pilot pressure) having passed through manipulation device 61. The detection signal showing the pilot pressure detected by pressure gauge 65 is input into main controller 40. The detection signal showing the pilot pressure detected by pressure gauge 65 is an example of the manipulation signal corresponding to the manipulation of manipulation device 61.

Pressure gauge 65 may be a pressure sensor that outputs an electrical signal proportional to the pilot pressure. When the pilot pressure detected by the pressure sensor is equal to or greater than a prescribed threshold value, for example, equal to or greater than 5 kg/cm², main controller 40 may determine that manipulation device 61 has been manipulated.

Pressure gauge 65 may be a pressure switch that is switched between ON and OFF when the pilot pressure reaches prescribed pressure. The threshold value of the pressure switch may be set at 5 kg/cm², for example. In this case, when the pressure switch is switched from OFF to ON, main controller 40 may detect that pressure occurs in pilot oil path 57, and then determine that manipulation device 61 has been manipulated.

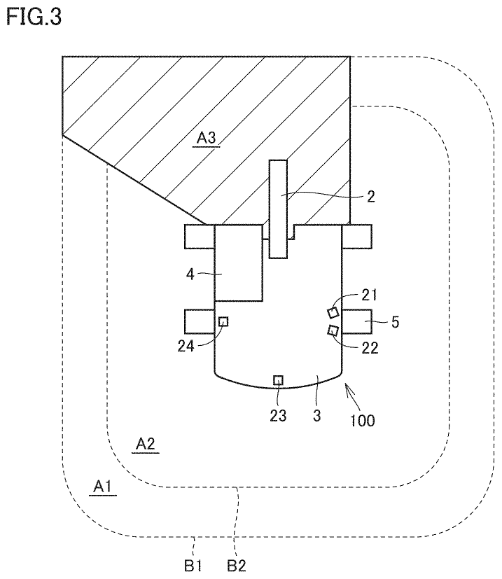

FIG. 3 is a schematic diagram for illustrating each of regions set in a surrounding area of hydraulic excavator 100. FIG. 3 schematically shows hydraulic excavator 100 in a plan view. In hydraulic excavator 100 shown in FIG. 3, revolving unit 3 changes its posture shown in FIG. 1 to be rotated by 90° with respect to traveling unit 5. In FIG. 3, the front-rear direction of revolving unit 3 corresponds to the up-down direction in the figure. Crawler belt 5Cr shown in FIG. 3 extends in the right-left direction of revolving unit 3.

As shown in FIG. 3, a first boundary line B1 and a second boundary line B2 are set in a surrounding area of hydraulic excavator 100. First boundary line B1 is set to be more distant from hydraulic excavator 100 than second boundary line B2 is. First boundary line B1 and second boundary line B2 are set to surround hydraulic excavator 100 and to extend substantially in parallel with each other.

First boundary line B1 extends as a boundary line employed as a reference for detecting that an obstacle as an object to be recognized (for example, a human) is present inside first boundary line B1, i.e., present close to hydraulic excavator 100 with respect to first boundary line B1. Second boundary line B2 extends as a boundary line employed as a reference for restricting the operation of hydraulic excavator 100 when an object to be recognized is present inside second boundary line B2, i.e., present close to hydraulic excavator 100 with respect to second boundary line B2. The region inside second boundary line B2 is referred to as a stop control region A2. The region between first boundary line B1 and second boundary line B2 is referred to as a sensing region A1.

A visible region A3 with a hatching pattern shown in FIG. 3 shows a region that is visible by an operator who is aboard cab 4 and faces forward. Visible region A3 is set forward of revolving unit 3. Visible region A3 is located at a dead angle from camera 20, and thus, not included in the images captured by right front camera 21, right side camera 22, rear camera 23, and left side camera 24. Sensing region A1, stop control region A2, and visible region A3 each are set in a surrounding area of hydraulic excavator 100. Stop control region A2 corresponds to a “set region” in the embodiment.

Camera 20 obtains images of the surrounding area of hydraulic excavator 100 excluding visible region A3. Camera 20 can obtain images showing the inside of sensing region A1, and can also obtain images showing the inside of stop control region A2. Surrounding area monitoring controller 30 determines whether or not the images obtained by camera 20 show an obstacle as an object to be recognized (for example, a human), to thereby detect whether an object to be recognized is present or not in the surrounding area of hydraulic excavator 100. From surrounding area monitoring controller 30, main controller 40 receives an electrical signal indicating the result of detecting whether an object to be recognized is present or not in the surrounding area of hydraulic excavator 100.

Camera 20 and surrounding area monitoring controller 30 constitute a surrounding area monitoring device in the embodiment. From the images showing the inside of sensing region A1 that are obtained by camera 20, surrounding area monitoring controller 30 detects whether an object to be recognized such as a human is present or not inside sensing region A1. From the images showing the inside of stop control region A2 as a set region that are obtained by camera 20, surrounding area monitoring controller 30 detects whether an object to be recognized such as a human is present or not inside stop control region A2.

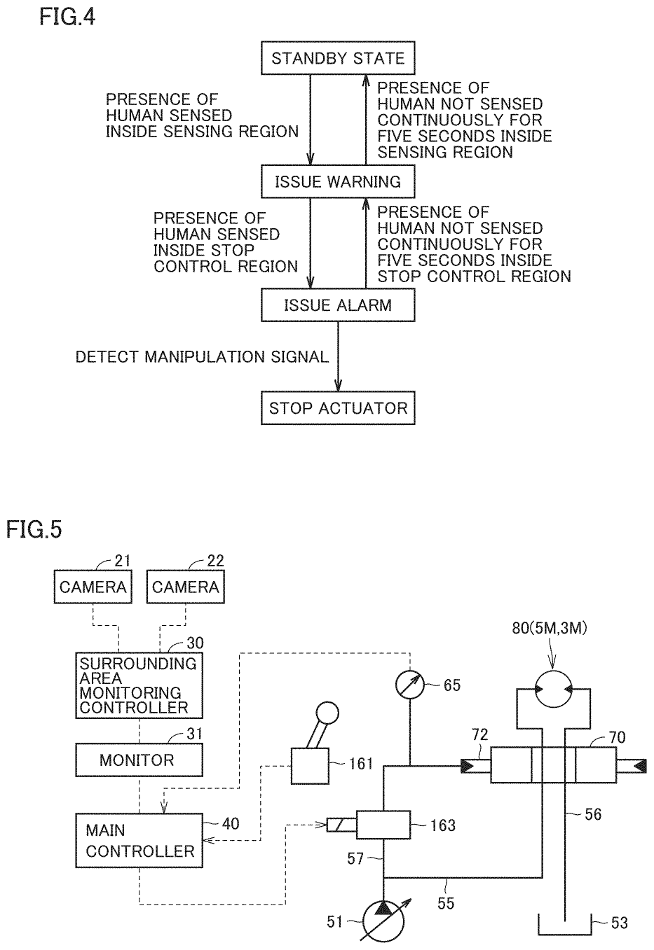

Main controller 40 performs an object sensing function. The object sensing function in the present embodiment is a function of restricting the operation of hydraulic excavator 100 upon detection that an object to be recognized such as a human is present inside stop control region A2. FIG. 4 is a schematic diagram showing each process performed by the object sensing function.

The standby state shown in FIG. 4 shows the state where an object to be recognized such as a human is not present inside sensing region A1 and stop control region A2. The operation of hydraulic excavator 100 is not restricted in the standby state. Neither alarm nor warning is issued in the standby state.

In the standby state, upon sensing that an object such as a human is present inside sensing region A1, a warning is issued. A warning may visually call operator's attention with an icon indicating this warning and displayed on monitor 31. A warning may acoustically call operator's attention with a buzzer and the like.

When the presence of a human is not sensed any more inside sensing region A1 during issuance of a warning and this state of sensing no presence of a human is continued for a prescribed time period, for example, for five seconds, issuance of the warning is stopped and the system is returned to the standby state.

When the presence of an object such as a human is sensed inside stop control region A2 during issuance of a warning, an alarm is issued. An alarm may visually call operator's attention with an icon indicating this alarm and displayed on monitor 31. An alarm may acoustically call operator's attention with a buzzer and the like. The buzzer issuing a warning may be the same device as the buzzer issuing an alarm. In order to allow an operator to recognize issuance of an alarm, for example, the interval of sounds intermittently issued from a buzzer may be shortened or the volume of a buzzer sound may be changed.

When the presence of a human is not sensed any more inside stop control region A2 during issuance of an alarm and this state of sensing no presence of a human is continued for a prescribed time period, for example, for five seconds, issuance of the alarm is changed to issuance of a warning.

In the case where manipulation device 61 is manipulated during issuance of an alarm, i.e., when it is detected that an object to be recognized is present inside stop control region A2, main controller 40 restricts the operation of hydraulic actuator 80 corresponding to the manipulation of manipulation device 61.

In this case, the determination that manipulation device 61 has been manipulated is made by detecting a manipulation signal. In the system configuration shown in FIG. 2, pressure gauge 65 detects pilot pressure fluctuations, and then, the detection signal thereof is input into main controller 40. Thereby, main controller 40 detects a manipulation signal. Main controller 40 having detected the manipulation signal immediately outputs a control signal to solenoid valve 63 so as to bring solenoid valve 63 into a closed state. Solenoid valve 63 in a closed state blocks pilot oil path 57 to thereby prevent fluctuations of the pilot pressure supplied to pilot port 72 of main valve 70, so that the spool of main valve 70 stops. Thereby, even when manipulation device 61 is manipulated, hydraulic oil is no longer supplied from hydraulic pump 51 to hydraulic actuator 80, with the result that the operation of hydraulic actuator 80 is restricted.

When manipulation device 61 is a traveling-motion manipulation device manipulated to cause hydraulic excavator 100 to travel and when it is detected that the traveling-motion manipulation device is manipulated during issuance of an alarm, main controller 40 restricts the operation of traveling motor 5M. Traveling motor 5M is an example of hydraulic actuator 80 corresponding to the manipulation of the traveling-motion manipulation device. Main controller 40 performs control to prevent traveling motor 5M from driving, and, if traveling motor 5M is operating, to stop the operation of traveling motor 5M to thereby prevent hydraulic excavator 100 from moving.

When manipulation device 61 is a revolving-motion manipulation device manipulated to operate revolving unit 3 to revolve and when it is detected that the revolving-motion manipulation device is manipulated during issuance of an alarm, main controller 40 restricts the operation of revolving motor 3M. Revolving motor 3M is an example of hydraulic actuator 80 corresponding to the manipulation of the revolving-motion manipulation device. Main controller 40 performs control to prevent revolving motor 3M from driving, and, if revolving motor 3M is operating, to stop the operation of revolving motor 3M to thereby prevent revolving motion of revolving unit 3.

On the other hand, when manipulation device 61 is manipulated to operate work implement 2 during issuance of an alarm, main controller 40 does not restrict the operations of boom cylinder 10, arm cylinder 11, and bucket cylinder 12. Hydraulic excavator 100 is controlled such that traveling and revolving of hydraulic excavator 100 are restricted as described above but the operation of work implement 2 is not restricted also during issuance of an alarm.

Even when the presence of a human is not sensed any more inside sensing region A1 after performing the process of stopping target hydraulic actuator 80 to restrict the operation of hydraulic excavator 100, the system is not returned to a standby state shown in FIG. 4. In order to allow the system to be returned to a standby state, the system may be configured to require a manual operation by an operator intended to return the system back to a standby state, for example, such as an operation of locking a lock lever once and then again unlocking the lock lever.

As described above, in hydraulic excavator 100 in the embodiment, when manipulation device 61 is manipulated in the case where it is detected that an object to be recognized such as a human is present inside stop control region A2, the operation of hydraulic actuator 80 corresponding to the manipulation of manipulation device 61 is restricted, as shown in FIG. 4.

According to the configuration in this case, in addition to whether an object is sensed or not inside stop control region A2, manipulation of manipulation device 61 is also applied as a condition for determining to interrupt supply of pilot pressure to main valve 70, to thereby stop the mechanical motion of hydraulic excavator 100. Instead of stopping hydraulic actuator 80 uniformly upon detection of the presence of a human inside stop control region A2, it can be arbitrarily changed whether or not to stop hydraulic actuator 80 in accordance with the details of the manipulation when manipulation device 61 is manipulated. Thus, the operation of hydraulic excavator 100 is restricted by the operator's intention only when required. Thereby, hydraulic excavator 100 can be improved in manipulability.

As shown in FIG. 2, manipulation device 61 outputs a manipulation signal corresponding to the manipulation of manipulation device 61. Upon detection of this manipulation signal, main controller 40 determines that manipulation device 61 has been manipulated. Manipulation device 61 causes fluctuations in the pilot pressure having passed through manipulation device 61. Then, pressure gauge 65 detects this pilot pressure and outputs the detection result to main controller 40. Based on the result of detecting the pilot pressure input from pressure gauge 65, main controller 40 determines that manipulation device 61 has been manipulated. Thereby, main controller 40 can accurately determine whether manipulation device 61 has been manipulated or not.

As shown in FIG. 2, hydraulic actuator 80 includes traveling motor 5M for driving traveling unit 5 that causes hydraulic excavator 100 to travel. When the traveling-motion manipulation device manipulated to cause hydraulic excavator 100 to travel is manipulated, main controller 40 may restrict the operation of traveling motor 5M. Thus, by controlling hydraulic excavator 100 not to travel, it becomes possible to reliably avoid that traveling hydraulic excavator 100 comes into contact with the obstacle present inside stop control region A2. Accordingly, the operator does not need to perform a special operation for preventing hydraulic excavator 100, which is traveling, from coming into contact with an obstacle. Also from such a viewpoint, hydraulic excavator 100 is improved in manipulability.

As shown in FIG. 2, hydraulic actuator 80 includes revolving motor 3M for driving revolving unit 3 to revolve. When the revolving-motion manipulation device manipulated to cause revolving unit 3 to revolve is manipulated, main controller 40 may restrict the operation of revolving motor 3M. By controlling revolving unit 3 not to revolve in this way, it becomes possible to reliably avoid that revolved revolving unit 3 comes into contact with the obstacle present inside stop control region A2. Accordingly, the operator does not need to perform a special operation for preventing revolving unit 3, which is revolving, from coming into contact with an obstacle. Also from such a viewpoint, hydraulic excavator 100 is improved in manipulability.

When revolving unit 3 is revolving or hydraulic excavator 100 is traveling, there is a possibility that hydraulic excavator 100 may come into contact with an obstacle. When an operator manipulates the revolving-motion manipulation device or the traveling-motion manipulation device, it is difficult for the operator to visually check work implement 2 and the vehicle body, and therefore, hydraulic excavator 100 may come into contact with an obstacle. Thus, when the revolving-motion manipulation device is manipulated, main controller 40 restricts the operation of revolving motor 3M to prevent revolving unit 3 from revolving. When the traveling-motion manipulation device is manipulated, main controller 40 restricts the operation of traveling motor 5M to prevent hydraulic excavator 100 from traveling. In accordance with the details of the manipulation by an operator, main controller 40 performs control to stop the operation of hydraulic excavator 100 that is expected to come into contact with an obstacle. Thereby, it becomes possible to reliably avoid that traveling or revolving hydraulic excavator 100 comes into contact with an obstacle.

In the case where a work implement manipulation device manipulated to operate work implement 2 is manipulated when the presence of a human is sensed inside stop control region A2, main controller 40 does not restrict the operation of work implement 2. When the operator who is aboard cab 4 operates work implement 2, the operator generally operates work implement 2 while looking at work implement 2 with his/her own eyes. Even when a human is present inside stop control region A2, but when the operator can visually check no presence of a human at the position where the operation of work implement 2 is influenced, the operation of work implement 2 is permitted to thereby allow the operator to freely move work implement 2. Thereby, hydraulic excavator 100 can be improved in manipulability.

### Second Embodiment

FIG. 5 is a block diagram showing a system configuration of a hydraulic excavator 100 according to a second embodiment. As compared with the system configuration in the first embodiment shown in FIG. 2, the system configuration in the second embodiment includes an electrical-type manipulation device 161 in place of manipulation device 61 and also includes a proportional solenoid valve 163 in place of solenoid valve 63.

Manipulation device 161 includes a manipulation lever. Manipulation device 161 outputs a detection signal indicating the direction and the amount of manipulation of the manipulation lever to main controller 40. In the second embodiment, the detection signal output from manipulation device 161 corresponds to the manipulation signal corresponding to the manipulation of manipulation device 161.

Main controller 40 outputs a control signal to proportional solenoid valve 163 according to the details of the manipulation of manipulation device 161, and controls the degree of opening of proportional solenoid valve 163. Main controller 40 adjusts the degree of opening of proportional solenoid valve 163 to change the pressure of the pilot oil flowing through pilot oil path 57 to thereby control the pilot pressure supplied to a pair of pilot ports 72 of main valve 70. Pressure gauge 65 detects the pilot pressure adjusted by proportional solenoid valve 163.

When the presence of a human is detected inside stop control region A2, manipulation device 161 is manipulated to input a manipulation signal to main controller 40, and thus, main controller 40 detects the manipulation signal. Main controller 40 having detected the manipulation signal immediately outputs a control signal to proportional solenoid valve 163 so as to bring proportional solenoid valve 163 into a fully closed state. Proportional solenoid valve 163 in a fully closed state blocks the pilot pressure, to thereby stop the spool of main valve 70. This prevents hydraulic pump 51 from supplying the hydraulic oil to hydraulic actuator 80 even when manipulation device 61 is manipulated. Thus, the operation of hydraulic actuator 80 corresponding to the manipulation of manipulation device 61 is restricted.

As in the first embodiment, the system configuration in the second embodiment can also arbitrarily change whether or not to stop hydraulic actuator 80 according to the details of the manipulation of manipulation device 161, with the result that hydraulic excavator 100 can be improved in manipulability.

### Third Embodiment

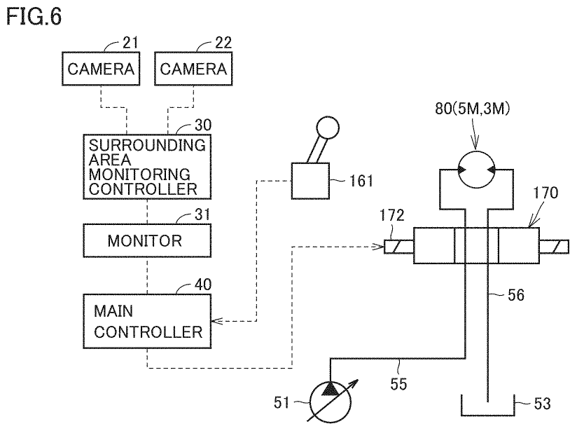

FIG. 6 is a block diagram showing a system configuration of a hydraulic excavator 100 according to a third embodiment. The system configuration in the third embodiment includes electrical-type manipulation device 161 as in the second embodiment. As compared with the system configuration in the second embodiment shown in FIG. 5, the system configuration in the third embodiment does not include pilot oil path 57. In the third embodiment, main valve 170 includes a solenoid driven-type spool 172 but does not include a pilot port.

Main controller 40 outputs a control signal to spool 172 according to the details of the manipulation of manipulation device 161 and controls the position of spool 172.

When the presence of a human is detected inside stop control region A2, manipulation device 161 is manipulated to input a manipulation signal to main controller 40, and thus, main controller 40 detects the manipulation signal. Then, main controller 40 having detected the manipulation signal immediately outputs a control signal to spool 172 so as to stop spool 172. This prevents hydraulic pump 51 from supplying the hydraulic oil to hydraulic actuator 80 even when manipulation device 61 is manipulated. Thus, the operation of hydraulic actuator 80 corresponding to the manipulation of manipulation device 61 is restricted.

As in the first embodiment, the system configuration in the third embodiment can also arbitrarily change whether or not to stop hydraulic actuator 80 according to the details of the manipulation of manipulation device 161, with the result that hydraulic excavator 100 can be improved in manipulability.

In the above description about the examples of the embodiments, hydraulic excavator 100 includes main controller 40, and main controller 40 mounted in hydraulic excavator 100 controls the operation of hydraulic excavator 100. The controller that controls the operation of hydraulic excavator 100 does not necessarily have to be mounted in hydraulic excavator 100.

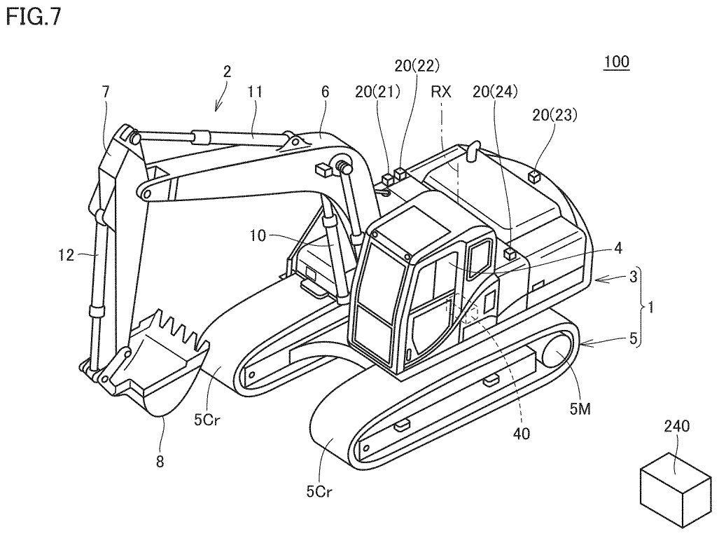

FIG. 7 is a schematic diagram of a control system for hydraulic excavator 100. An external controller 240 provided separately from main controller 40 mounted in hydraulic excavator 100 may configure a control system for hydraulic excavator 100. Controller 240 may be disposed at the worksite of hydraulic excavator 100 or at a remote location distant from the worksite of hydraulic excavator 100.

In the above explanation, hydraulic excavator 100 has been described as an example of a work machine, but the work machine to which the concept of the present disclosure is applicable may be a wheel loader, a motor grader, a crane, and the like.

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

### REFERENCE SIGNS LIST

1 body, 2 work implement, 3 revolving unit, 3M revolving motor, 5 traveling unit, 5Cr crawler belt, 5M traveling motor, 6 boom, 7 arm, 8 bucket, 10 boom cylinder, 11 arm cylinder, 12 bucket cylinder, 20 camera, 21 right front camera, 22 right side camera, 23 rear camera, 24 left side camera, 30 surrounding area monitoring controller, 31 monitor, 40 main controller, 51 hydraulic pump, 53 tank, 55 hydraulic oil supply path, 56 hydraulic oil discharge path, 57 pilot oil path, 61, 161 manipulation device, 63 solenoid valve, 65 pressure gauge 70, 170 main valve, 72 pilot port, 80 hydraulic actuator, 100 hydraulic excavator, 163 proportional solenoid valve, 172 spool, 240 controller, A1 sensing region, A2 stop control region, A3 visible region, B1 first boundary line, B2 second boundary line, RX revolving axis.

1. A work machine comprising:
a manipulation device that is manipulated to operate the work machine;
an actuator that drives the work machine in a manner corresponding to a manipulation of the manipulation device;
a surrounding area monitoring device that detects whether an object to be recognized is present or not inside a set region that is set in a surrounding area of the work machine; and
a controller that controls the work machine, wherein
when the manipulation device is manipulated in a case where it is detected that the object is present inside the set region, the controller restricts an operation of the actuator corresponding to a manipulation of the manipulation device.

2. The work machine according to claim 1, wherein
the manipulation device outputs a manipulation signal corresponding to a manipulation of the manipulation device, and
the controller determines that the manipulation device is manipulated when the controller detects the manipulation signal.

3. The work machine according to claim 1, wherein
the work machine includes a traveling unit that causes the work machine to travel,
the manipulation device includes a traveling-motion manipulation device that is manipulated to cause the work machine to travel,
the actuator includes a traveling actuator that drives the traveling unit, and
when the traveling-motion manipulation device is manipulated in a case where it is detected that the object is present inside the set region, the controller restricts an operation of the traveling actuator.

4. The work machine according to claim 1, wherein
the work machine includes a revolving unit that is capable of revolving with respect to a ground surface,
the manipulation device includes a revolving-motion manipulation device that is manipulated to cause the revolving unit to revolve,
the actuator includes a revolving actuator that drives the revolving unit to revolve, and
when the revolving-motion manipulation device is manipulated in a case where it is detected that the object is present inside the set region, the controller restricts an operation of the revolving actuator.

5. A control system for a work machine, the control system comprising:
a manipulation device that is manipulated to operate the work machine;
an actuator that drives the work machine in a manner corresponding to a manipulation of the manipulation device; and
a surrounding area monitoring device that detects whether an object to be recognized is present or not inside a set region that is set in a surrounding area of the work machine, wherein
when the manipulation device is manipulated in a case where it is detected that the object is present inside the set region, the control system restricts an operation of the actuator corresponding to a manipulation of the manipulation device.
